(19) United States
(12) Patent Application Publication
(10) Pub. No.: US 2008/0014331 A1
(43) Pub. Date: Jan. 17, 2008

(54) Super sweet sugar crystals and syrups for health and method

(76) Inventor: Constantin Badalov, Catherines (CA)

Correspondence Address: Donald W. Meeker;Patent Agent, 924 East Ocean Front #E, Newport Beach, CA, 92661, US

(21) Appl. No.: 11/487,933

(22) Filed: Jul. 17, 2006

(51) Int. Cl. A23G 3/00

(52) U.S. Cl. 426/658

(57) ABSTRACT

A method for making novel health benefiting super sweet sugar crystals and super sweet sugar syrups and super sweet molasses for use in a wide variety of health benefiting super sweeteners and indigestible health benefiting nutritional compositions.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to sugars and methods of making sugars and in particular to a method for making novel health benefiting super sweet sugar crystals and super sweet sugar syrups for use in a wide variety of health benefiting super sweeteners and ingestible health benefiting nutritional compositions.

2. Description of Related Art Including Information Disclosed Under 37 CFR 1.97 and 1.98

Contrary to a strong widespread perception that sugar is bad for you, the scientific fact of the matter is that sugar is an extremely essential nutrient for the energy, growth and healthy development of children and the human body in general. The health issues start to evolve only, when humans:

1) consume sugar in high, sometimes in extremely high doses, and
2) overconsume sugar during prolonged periods of time, and overconsumption of sugar rich products becomes a lifelong habit.

Regularly eating large amounts of sugar might cause serious harm, as it was indicated earlier. Overconsumption of sugar can cause:

### 1) Hypoglycemia and weight gain, leading to diabetes and obesity in both children and adults;

### 2) Leaching the body of vital minerals and vitamins;

### 3) Raising blood pressure, triglycerides, and the bad cholesterol (LDL), increasing the risk of heart disease;

### 4) Causing tooth decay and periodontal disease, which leads to tooth loss and systemic infections;

### 5) Initiating auto-immune and immune deficiency disorders such as arthritis, allergies, and asthma;

### 6) Upsetting hormonal balance and supporting the growth of cancer cells.

Artificial sweeteners have had a very limited impact on sugar consumption because

1) on one hand they lack the physical characteristics, such as bulk, texture, crystallization, heat and acid stability, necessary in most food applications and
2) on the other hand they leave issues of health safety and
3) many of them lack the same organoleptic properties as sugars

Overall, the use of artificial sweeteners has not displaced sugar consumption, but has created a new market satisfying consumer demand for lower calorie alternatives.

Comparing prior inventions and patents, the sweeteners are made by different processes from the present invention. Most of them are made by either:

1) mixing dry components of crystal sugar and other high intensity sweetener, or mixing them in water solutions, for example U.S. Pat. No. 6,703,057;
2) by spray drying water based sugar syrup, U.S. Pat. No. 5,061,320; or
3) “co-crystallizing” commercially available sugar with HIS (High Intensity Sweetener) by “impact beating” (vigorous mechanical agitation), U.S. Pat. No. 6,214,402, or
4) recrystallizing sugar by extrusion and impact beating, U.S. Pat. No. 5,549,757.

For example, in U.S. Pat. No. 5,061,320, the sweetener is prepared by spray drying a sucrose syrup incorporated with a high intensity sweetener (sugar in water solution) to achieve the sweetness of their sweetener equal to sucrose.

Mixing dry components of sugar and sweetener or their water solutions does not achieve the good quality of a new sweetener, making it inconsistent and thus unequally sweet. Primarily because during storage, handling and/or transportation the dry mixed components of sugar and high intensity sweetener, which have different bulk density and crystal sizes, tend to clearly form separate layers from each other, or become unequally dispersed from each other. Smaller crystals in a dry mixture, for example, will be shaken down to the bottom part of a container or a package and the water solutions need to be constantly mixed to achieve the homogeny of sweetness.

The following prior art patents although attempting to produce sugar efficiently have not succeeding in solving the sugar problem.

| PATENT NUMBER | INVENTOR | DATE |
|---|---|---|
| U.S. Pat. No. 3,619,294 | W C Black et al. | Nov. 9, 1971 |
| U.S. Pat. No. 4,362,757 | A C C Chen et al. | Dec. 7, 1982 |
| U.S. Pat. No. 5,061,320 | B C Goodacre et al. | Oct. 29, 1991 |
| U.S. Pat. No. 5,401,519 | E Sabase et al. | Mar. 28, 1995 |
| U.S. Pat. No. 5,549,757 | J R Morano | Aug. 27, 1996 |
| U.S. Pat. No. 5,779,805 | J R Morano | Jul. 14, 1998 |
| U.S. Pat. No. 6,074,489 | J R Morano | Jun. 13, 2000 |
| U.S. Pat. No. 6,123,980 | T N Pearson et al. | Sep. 26, 2000 |
| U.S. Pat. No. 6,214,402 | J Fotos et al. | Apr. 10, 2001 |
| U.S. Pat. No. 6,558,722 | C L Corriveau et al. | May 6, 2003 |
| U.S. Pat. No. 6,703,057 | W Duffett | Mar. 9, 2004 |
| U.S. Pat. No. 6,821,547 | P Shah et al. | Nov. 23, 2004 |
| WO 8,909,287 | G Smits et al. | Jun. 9, 1993 |
| U.S. Pat. No. 4,746,520 | G Smits et al. | May 24, 1988 |
| EP 0545,890 | G Smits et al. | Oct. 5, 1989 |
| U.S. Pat. No. 4,254,154 | Eisenstadt; Marvin E. | Oct. 30, 1978 |

There is thus a need for a pure sucrose-based high intensity sweetener, which not only have sufficient carbohydrate present to provide the structural requirements, bulk, texture, crystallization, heat and acid stability necessary in most food applications, but also the one that will significantly reduce the amount of sugar needed, having a higher bulk sweetening power than sucrose with much lower calories; providing substantially the same organoleptic properties as sugars, that is sweetening product that does not leave the unpleasant after-taste of the known high intensity sweeteners.

### BRIEF SUMMARY OF THE INVENTION

Primary objects of the present invention are to provide a method for making a pure sucrose-based much safer, more natural sweetener, which not only have sufficient carbohydrate present to provide the structural requirements, bulk, texture, crystallization, heat and acid stability necessary in most food applications, but also the one that:

1) will significantly reduce the amount of sugar needed for consumption,
2) have a higher balk sweetening power than sucrose with much lower calories;
3) provide substantially the same organoleptic properties as sugars, that is sweetening product that does not leave the unpleasant after-taste and health related safety concerns of the known high intensity sweeteners and
4) provide indispensable health benefiting qualities as sweetener in foods and drinks.

Another object of the present invention is to provide a new sugar refining process that makes sucrose extracted from sugar beets and sugar cane several times sweeter than regular sugar.

Another object of the present invention is to provide super sweet sugar crystals, super sweet sugar syrups and super sweet sweeteners formulated to provide a much needed healthy solution to a widespread, global health debilitating overconsumption and addiction to sweet products with very high sugar content and related health issues of: obesity, diabetes, high blood pressure, cholesterol, cancer, arthritis, allergies, tooth decay and others.

Primary objects of the present invention are to provide a method for making a pure sucrose-based much safer, more natural sweeteners, which have sufficient carbohydrate present to provide the structural requirements, bulk, texture, crystallization, heat and acid stability necessary in most food applications.

In brief, by applying the process described in present invention with 99.52% of sucrose and 0.48% of Steviaside extract (SEV=250), the sugar of the present invention will be 3 times sweeter than regular prior art sugar. In practical application, 1 tsp of the sugar of the present invention will substitute for 3 tsp of regular sugar, and thus will have 3 times less calories, 3 times lower glycemic affect, 3 times less tooth decay, 3 times less weight, and less volume and shelving space to reduce transportation and warehousing costs.

An advantage of the present invention is that it will significantly reduce the amount of sugar needed for consumption.

Another advantage of the present invention is that it will have a higher balk sweetening power than sucrose with much lower calories.

A further advantage of the present invention is that it provides substantially the same organoleptic properties as sugars, that is sweetening product that does not leave the unpleasant after-taste and health related safety concerns of the known high intensity sweeteners.

One more advantage of the present invention is that it provides indispensable health benefiting qualities as sweetener in foods and drinks.

A still further advantage of the present invention is that by applying the process described in present invention with 99.52% of sucrose and 0.48% of Steviaside extract (SEV=250), the sugar of the present invention will be 3 times sweeter than regular prior art sugar. In practical application, 1 tsp of the sugar of the present invention will substitute for 3 tsp of regular sugar, and thus will have 3 times less calories, 3 times lower glycemic affect, 3 times less tooth decay, 3 times less weight, and less volume and shelving space to reduce transportation and warehousing costs.

### BRIEF DESCRIPTION OF THE SEVERAL VIEWS OF THE DRAWINGS

Not Applicable.

### DETAILED DESCRIPTION OF THE INVENTION

A method for increasing the sweetness of regular sugar made during the refining process of sugar beets and sugar cane, the method comprising:

a) a first step of forming a mixture of raw juice extracted from sugar cane or sugar beets with a milk of lime and a carbon dioxide gas in carbonation tanks so that the carbon dioxide bubbles through the mixture forming calcium carbonate and non-sugar particles in the mixture attach themselves to the calcium carbonate and settle to the bottom of the tanks;
b) a second step of filtering the mixture, leaving a golden light brown clarified thin juice,
c) a third step of boiling the juice under vacuum until a sufficient quantity of water is evaporated from the juice to form a syrup having a consistency of pancake syrup;
d) a fourth step of filtering the syrup in an after filter to remove all non-sugar materials to form a saturated sugar liquor;
e) a fifth step of mixing the saturated sugar liquor with at least one high intensity sweetener in a large mixer;
f) a sixth step of transferring the mixture the saturated sugar juice and the at least one high intensity sweetener to boiling pans and boiling the mixture of saturated sugar juice and at least one high intensity sweetener under vacuum until crystals begin to form a super sweet massecuite comprising a mixture of super sweet sugar crystals and super sweet syrup;
g) a seventh step of transferring the super sweet massecuite to centrifuges for separation by spinning rapidly in a perforated cylindrical basket to form a molasses syrup thrown off through perforations in the perforated cylindrical basket with the super sweet sugar crystals remaining in the perforated cylindrical basket;
h) an eighth step of processing further the super sweet molasses syrup that remains after the sugar crystals are initially separated by removing more super sweet sugar crystals from the remaining molasses to produce a super sweet sugar syrup.

The method may produce an amount of sucrose in the super sweet sugar syrup is more than 99% and the super sweet sugar syrup has a Sucrose Equivalent Value (SEV) from at least 150% to 3000%.

The method further comprises a ninth step of washing the super sweet sugar crystals in clean hot water to produce pure white damp super sweet sugar crystals;

The method further comprises a tenth step of drying the damp super sweet sugar crystals with filtered air in a rotating drum granulator and passing the dried new super sweet sugar crystals over screens which separate the various sizes of the new super sweet sugar crystals.

The method further comprises an eleventh step of drying each of the various sizes of the new super sweet sugar crystals through a curing process and then packaging the various sizes of the new super sweet sugar crystals into various retail and commercial packages for shipping to stores and food manufacturers.

The method produces super sweet sugar crystals which are formed to be at least 1.5-30 times sweeter than regular sucrose.

The method produces an amount of sucrose in the super sweet sugar crystals which is more than 99% and the super sweet sugar crystals have a Sucrose Equivalent Value (SEV) from at least 150% to 3000%.

In the fifth step, the method comprises mixing the saturated sugar liquor with at least one high intensity sweetener in a large mixer, the high intensity sweetener taken from a list of high intensity sweeteners including: a sweet protein taken from the list of sweet proteins including Stevioside and rebaudiside-A extract, Lo Han Guo Mogrosides extract, Brazzein, Curculin, Glycyrrhizin, Thaumatin, Monellin, Pentadin, Mabinlin as natural sweeteners; Acesulfame Potassium, Sucralose, Neotam, Talin, Thaumatin, Citrose, Alitame, Cyclamate, Saccharin; a sugar alcohols taken from the list of sugar alcohols including erythritol, xylitol, sorbitol, lactitol, mannitol, and maltitol; Tagatose, Inulin-FOS (FructoOligoSaccharide); and other sweeteners.

In the fifth step, the method then further comprises mixing the saturated sugar liquor with at least one natural sweetener taken from the list of natural sweeteners including: fructose, isoglucose, natural honey, artificial honey, maple syrup, amasake, barley malt, brown rice syrup, concentrated fruit sweetener, date sugar, tagatose, sugar alcohols, and Inulin-FOS; and mixing the saturated sugar liquor and natural sweetener mixture with the mixture of the saturated sugar juice and the at least one high intensity sweetener.

The method produces an amount of sucrose alone in the super sweet sugar syrup and the super sweet sugar crystals or a combination of sucrose and at least one of the group of natural sweeteners including fructose, glucose, honey, maple syrup, tagatose, sugar alcohols, inulin-FOS in the super sweet sugar syrup and the super sweet sugar crystals comprises between 75-99% and the Sucrose Equivalent Value (SEV) is greater than 3000%.

The method produces super sweet sugar crystals and the super sweet sugar syrup each contain at least 99% sucrose to reduce calorie intake and glycemic effect due to increased sweetness without increase of calories and to enable proportionate reduction of the amount of regular sugar and carbohydrates needed for sweetening foods and beverages so that the weight, volume, amount of carbohydrate and energy (calorie value) of which will be proportionately reduced by number of times the super sweet sugar crystals and the super sweet sugar syrup are each sweeter then regular sugar to help to prevent health problems associated with excess sugar consumption including obesity, atherosclerosis, diabetes, and tooth decay.

In the fifth step the method may further comprise mixing the saturated sugar liquor with at least one of the following list of sweeteners including the sweeteners artificial maple syrup, a soluble fiber Inulin-FOS (FructoOligoSaccharide), stevia extract, a Lo Han Guo extract, and Neotame to make the saturated sugar liquor sweeter and to enhance health and other benefiting qualities of granulated sugars including assisting in breast cancer prevention and treatment for women, assisting in the prevention and elimination of viruses spread including hepatitis C, immune deficit virus, pneumonia virus, SARS virus (sugars containing flavoring agent Glycyrrhizin), enhancing a prebiotic effect and digestion by enhancing and promoting beneficial intestinal bacterial growth in the large intestine after consumption of food, assisting in the prevention of ear, nose and throat infections, osteoporosis, insulin resistance, diabetes, hypertension, and hormonal imbalances.

In the fifth step the method may further comprise mixing the saturated sugar liquor with from fifteen to thirty-two percent each of Cyclimate, Acesulfame K and Saccharine and from fifty-five to four percent proportionally of at least one of the following additives including the additives Sucralose, Citrose, Neatame, Thaumatin, Talin, Alitame, Steviaside, Lo Han Guo, and Glycyrrhizin.

In the fifth step, the method may comprise mixing the saturated sugar liquor with Lo Han Guo, Tagatose, Glycyrrhizin, and Steviaside.

In the fifth step, the method may comprise mixing the saturated sugar liquor with Xylitol, Lo Han Guo, Tagatose, Glycyrrhizin, and Steviaside.

In the fifth step, the method may comprise mixing the saturated sugar liquor with Erythritol, Lo Han Guo, Tagatose, Glycyrrhizin, and Steviaside.

In the fifth step, the method may comprise mixing the super saturated sugar liquor or novel super sweet crystallized sugars with therapeutically effective and regulatory safe dosages of at least one of the following list of ingredients including the ingredients Bromelain; Chitosan; Salicin; Inosin; Myoglobin; Glucomannan; Guaranine; Yerba mate, Pectin; Pancreatin; Pantothenic Acid; Spirulina; Adenosine Tri-Phosphate; Conjugated Linoleic Acid (CLA); Hydroxycitic Acid (HCA); Phaseolamin; 5HTP; Adenosine receptor antagonists including caffeine, theobromine, theophylline, SCH 58261, KW 6002, cocoa powder, coffee, and ZM 241385; Lecithin; Choline and inositol; Gamma-aminobutyric acid (QABA); Dehydroepiandrosterone (DHEA); Amino acids including L-Arginine, L-Ornithine, L-lysine, L-Carnitine, L-Glutamine, L-Methionine, L-Phenylalanine; L-Tyrosine, L-Cysteine, and L-methionine; Enzymes including Superoxide Dismutase (SOD), papain, bromelain, proteolytic and pancreatic enzymes; antioxidants including Alpha-Lipoic Acid, Bilberry, Coenzyme Q10, Cysteine, Ginkgo Biloba, Glutathione, Grape Seed Extract, Green Tea, Melatonin, Oligomeric Proanthocyanidins (OPCs) from pine bark (Pycnogenol), Taurine and grape seed extracts; vitamins including C, A, Beta-Carotene, D, E, B1, B2, B3, B5, B6, B12, B-complex, Biotin, Choline, and Folic Acid; minerals including Selenium, Zinc, Boron, Calcium, Chromium, Copper, Iron, Magnesium, and Potassium; and Aspartame.

The method may further comprises adding the super sweet sugar crystals and/or super sweet sugar syrup to at least one consumable item taken from the list of consumable items including meal replacements; baked and fried goods including doughnuts, muffins, cakes, pizzas, potato chips, corn chips, and french-fries; cereals; bakery fillings; dairy products including ice cream products, cheeses, yogurts, and frozen yogurts; soy beverages; soy products; chocolate; chocolate bars; sport performance nutritional products; candies; puddings; chewing gums; sweet coatings for nuts; and other snack products.

The method may further comprise mixing the super sweet sugar crystals and super sweet sugar syrup with at least one orally ingestible health benefiting nutritional compositions for humans and animals taken from the list of ingestible health benefiting nutritional compositions for humans and animals including super sweeteners; nutritional supplements including proteins including casein, soya protein isolates, spirulina, and egg albumin used in protein powder, protein and water base solutions, protein in water based beverages, amino acid powder, amino acid water based solutions, and amino acid water based beverages, and fats including butter, olive oil, canola oil, vegetable oil, flax seed oil, black currant seed oil, primrose oil, fish oil, and Omega 3, 6, 9 polyunsaturated fatty acids, dry coffee extracts, coffee extract beverages, cacao, black teas, green teas, milk, condensed milk, honey, maple syrup, dry fruit, vanillin, dry vegetables, ice cream, yogurt, wheat flower, multigrain flower, cheeses, nuts, mixtures of protein and fat, mixtures of protein and polyunsaturated fatty acids, mixtures of amino acids and fat, and mixtures of amino acids and polyunsaturated fatty acids; fruit juices; vegetable juices; fruit beverages; vegetable beverages; concentrated fruit juices; concentrated vegetable juices, concentrated fruit beverages, concentrated vegetable beverages; solutions of gelatin in water; solutions of pectin in water; and solutions of agar in water.

The method may further comprise adding the super sweet sugar crystals and super sweet sugar syrup to at least one composition for obesity, weight loss and cholesterol reduction from the list of compositions for obesity, weight loss and cholesterol reduction including conjugated Linoleic Acid (CLA); Hydroxycitic Acid (HCA) derived from a fruit, Garcinia cambogia or Malabar tamarind; Phaseolomine derived from white kidney beans; 5HTP; Lecithin; Choline; Inositol; Dehydroepiandrosterone (DHEA); Amino acids including Taurine, L-Arginine and L-ornithine plus L-lysine, L-Carnitine, L-Methionine; and vitamins and minerals including C, B2, B6, B12, Zinc, Calcium, and Chromium picolinate.

The method may further comprise mixing the super sweet sugar crystals and super sweet sugar syrup with at least one composition for sugar and sweets craving control taken from the list of compositions for sugar and sweets craving control including L-Glutamine, Vit. B3 (niacin), Phaseolamine, and Chromium picolinate,

The method may further comprise mixing the super sweet sugar crystals and super sweet sugar syrup with at least one composition for “appetite arrest and energy everest” taken from the list of compositions for “appetite arrest and energy everest” including Gamma-aminobutyric acid (GABA), L-Tyrosine, L-Phenylalanine, 5HTP, Phaseolomine, Glucomannan.

The method may further comprise mixing the super sweet sugar crystals and super sweet sugar syrup with at least one composition to boost energy and elevate depression taken from the list of compositions to boost energy and elevate depression including Gotu Kola; Saint John's Wort; Wheatgrass; Spirulina; Fennel; Kelp; Alfalfa; Red Clover; Adenosine A(2A) receptor blockers including caffeine, theobromine, theophylline, SCH 58261, KW 6002, and ZM 241385; Ephedra; guarana; kola nut; free-form amino acid complex; L-glutamine; L-tyrosine; S-adenosylmethionine (SAM); derivative of amino acid L-methionine; Pantothenic Acid; and Taurine.

The method may further comprise mixing the super sweet sugar crystals and super sweet sugar syrup with at least one composition for reduction of high blood pressure and prevention of heart disease taken from the list of compositions for reduction of high blood pressure and prevention of heart disease including L-Carnitine; L-glutamic acid; L-glutamine; Taurine; DHEA; Odorless Garlic; Coenzyme Q10; essential fatty acids including black currant seed oil, flax seed oil, olive oil, and primrose oil; Vitamin C; Calcium; Magnesium; Selenium; and Pectin.

The method may further comprise mixing the super sweet sugar crystals and super sweet sugar syrup with at least one composition for weight loss, cholesterol reduction, energy boost, antidepression and high blood pressure reduction, and diabetes taken from the list of compositions for weight loss, cholesterol reduction, energy boost, antidepression and high blood pressure reduction, and diabetes including conjugated Linoleic Acid (CLA); Hydroxycitic Acid (HCA) derived from a fruit, Garcinia cambogia or Malabar tamarind; Phaseolomine derived from white kidney beans; 5HTP; Lecithin; Choline; Inositol; Dehydroepiandrosterone (DHEA); Amino acids including Taurine, L-Arginine and L-omithine plus L-lysine, L-Carnitine, L-Methionine; vitamins and minerals including C, B2, B6, B12, Zinc, Calcium, and Chromium picolinate; L-Glutamine; Vit. B3 (niacin); Phaseolamine; Chromium picolinate; Gamma-aminobutyric acid (GABA); L-Tyrosine; L-Phenylalanine; 5HTP; Phaseolomine, Glucomannan; Gotu Kola; Saint John's Wort; Wheatgrass; Spirulina; Fennel; Kelp; Alfalfa; Red Clover; Adenosine A(2A) receptor blockers including caffeine, theobromine, theophylline, SCH 58261, KW 6002, and ZM 241385; Ephedra; guarana; kola nut; free-form amino acid complex; L-glutamine; L-tyrosine; S-adenosylmethionine (SAM); derivative of amino acid L-methionine; Pantothenic Acid; Taurine; Odorless Garlic; Coenzyme Q10; essential fatty acids including black currant seed oil, flax seed oil, olive oil, and primrose oil; Vitamin C; Calcium; Magnesium; Selenium; and Pectin.

The method may further comprise mixing the super sweet sugar crystals and super sweet sugar syrup with at least one composition for rheumatoid arthritis, sport and automobile related injuries, and headaches taken from the list of compositions for rheumatoid arthritis, sport and automobile related injuries, and headaches including Bromelain, Salicin and oil of evening primrose.

The method may further comprise mixing the super sweet sugar crystals and super sweet sugar syrup with Salicin for mild colds, influenza, headaches, pain, and smooth skin.

The method may further comprise mixing the super sweet sugar crystals and super sweet sugar syrup with at least one composition for B protection from the effects of the exposure to environmental toxicity, pollution, and cancer prevention taken from the list of compositions for B protection from the effects of the exposure to environmental toxicity, pollution, and cancer prevention including antioxidants; DHEA; Enzymes; Apple pectin; Iscador; Amino acids including L-Cystine, L-methionine, L-carnitine; and Vitamins including C, A, and E.

The method may further comprise mixing the super sweet sugar crystals and super sweet sugar syrup with at least one composition for elimination and control of drug addiction taken from the list of compositions for elimination and control of drug addiction including Vitamin B complex; Vitamin B12; Vitamin C; Calcium; magnesium; protein powder; Lecithin; free-form amino acid complex; L-glutamine; L-tyrosine; S-adenosylmethionine (SAM); Gamma-aminobutyric acid (GABA); Glutathione; decoction of common oats (Avena sativa); Lithium; L-phenylalanine; Niacinamide; Gotu Kola; Wheatgrass; Spirulina; Fennel; Kelp; Alfalfa; ephedra; guarana; and kola nut.

The method may further comprise mixing the super sweet sugar crystals and super sweet sugar syrup with at least one composition for elimination and control of alcohol addiction taken from the list of compositions for elimination and control of alcohol addiction including Glutathione; L-methionine; free form amino acid complex; L-cysteine; N-acetilcysteine; L-glutamine; L-tyrosine; S-adenosylmethionine (SAM); Pantothenic acid (vitamin B5); Vitamin B1 (thiamine); Vitamin B complex; Vitamin B12; Vitamin C with bioflavonoids; Calcium; magnesium; Gotu Kola; Wheatgrass; Spirulina; Fennel; Kelp; Alfalfa; Ephedra; guarana; and kola nut.

The method may further comprise mixing the super sweet sugar crystals and super sweet sugar syrup with at least one composition for elimination and control of smoking addiction taken from the list of compositions for elimination and control of smoking addiction including decoctions of herbal constituents Gotu Kola, Wheatgrass, Spirulina, Fennel, Kelp, Alfalfa, Dong Quai, Red Clover, and Ginger Root; common oats (Avena sativa; Schizandra; Alfalfa; Echinacea; Licorice Root; Catnip; Passion Flower; Lobelia; Hops; Skullcap; Peppermint; Gentian; Myrrh; Safflower, Bayberry root bark; Eucalyptus; Sarsaparilla; Slippery Elm; and Valerian root; Ephedra; guarana; kola nut; free-form amino acid complex; L-glutamine; L-tyrosine; S-adenosylmethionine (SAM); Copper; folic acid; L-Cystine; potassium; selenium; zinc; and Vitamins including A, C, B12, and E.

The method may further comprise mixing the super sweet sugar crystals and super sweet sugar syrup with at least one composition to enhance athletic performance and bodybuilding taken from the list of compositions to enhance athletic performance and bodybuilding including Inosin; Myoglobin; and Pantothenic acid (vitamin B5).

The method may further comprise mixing the super sweet sugar crystals and super sweet sugar syrup with at least one composition to slowing aging and increase of the muscle mass with the body fat reduction, help prevent osteoporosis, and increase of sex drive for both men and women taken from the list of compositions to slowing aging and increase of the muscle mass with the body fat reduction, help prevent osteoporosis, and increase of sex drive for both men and women taken including Omithine; Arginine; Carnitine; DHEA; ginkgo biloba; evening primrose oil; yerba mate; flavonoids; green tea; folic acid; vitamin B12; vitamin E; and vitamin C.

In the present invention the method produces super sweet sucrose and other sweeteners based sugars consisted of crystals with equal bulk density, size and sweetness.

It was determined that the sweetness of the final crystallized sugar will increase two times more than regular, when 1220-1250 mL of saturated sugar liquor (with approximately 80% of sugar content), extracted during sugar cane or sugar beets refining process after final filtration of saturated sugar liquor, sweetened with 3.2 g of stevioside extract with SEV (sucrose equivalent value)=250.

A solution of 2.3 g (half of a tea spoon) of novel sweetened sugar in 230 ml of water (1%) was equally sweet compared to the standard 2% solution of sucrose (Redpath granulated sugar in tap water, pH about 8.0), containing 4.6 g (1 tsp) of regular crystal sugar in 230 ml of water.

New crystallized sugar consequently contained 0.32% of Stevioside extract and 99.68% of sucrose and was 2 times sweeter than regular sugar.

It was determined that the sweetness of final crystallized sugar will increase 3 times as regular, when 1220-1250 mL of saturated sugar liquor (with approximately 80% of sugar content), extracted during sugar cane or sugar beets refining process after final filtration sweetened with 4.8 g of stevioside extract with SEV (sucrose equivalent value)=250.

New crystallized sugar consequently contained 0.48% of Stevioside extract and 99.52% of sucrose and was 3 times sweeter than regular sugar.

6.4 g of stevioside extract in 1220-1250 mL of saturated sugar liquor (with approximately 80% of sugar content), during the sugar cane or sugar beets refining process increased the sweetness of final granulated sugar 4 times.

New crystallized sugar consequently contained 0.64% of Stevioside extract and 99.36% of sucrose and was 4 times sweeter than regular sugar.

Similar results of increased sugar sweetness were found using other sweeteners with different sweetening power, stable to high heat and increased pressure. The increases in sweetness of new crystallized sugar at the end of the sugar refining process were determined further depending on the amounts of other sweeteners added to filtered sugar juice and sweetening power of each sweetener. See the results in Table 1. From the results, comprised in Table 1 it is clearly seen that new sugars can be made with SEV reaching up to 3000% and more, having at the same time the sucrose content equal to 99% and over.

Breast cancer prevention and treatment for women (novel sugars, containing Neotame sweetener, (Tamoxifen) has been used to treat both advanced and early stage breast cancer. It has been used for nearly 20 years to treat patients with advanced breast cancer. The SEV of novel sugar can be increased up to or more than 270 times, having at the same time the sucrose content over 99%. The weight, volume, amount of carbohydrate and energy (calorie value) of which will be proportionately reduced by number of times it is sweeter than regular sugar.

Sugars containing the flavoring agent Glycyrrhizin assist in the prevention and elimination of viruses spread including hepatitis C, immune deficit virus, pneumonia virus, and SARS virus.

A prebiotic effect and digestion enhancing and promotion of beneficial intestinal bacterial growth in the large intestine is observed after consumption of food, containing novel sugars, incorporated with Inulin-FOS (FructoOligoSaccharide), and Tagotose.

Ear, Nose & Throat Infections, and Osteoporosis are aided by sugars containing Xylitol.

All of the above super sweet new sugars, and especially those containing Xylitol aid in Insulin Resistance, Diabetes Hypertension, and Hormonal Imbalances.

Conjugated Linoleic Acid, CLA is a fatty acid that has been found to reduce cancer risks, body fat and to increase lean muscle tissue. CLA does occur naturally in meat and dairy products, but the levels are pretty low.

Hydroxycitic Acid, HCA, is derived from a fruit, Garcinia cambogia or Malabar tamarind. It works by inhibiting an enzyme that converts carbohydrates to fat. It also suppresses the appetite.

Phaseolomine is derived from the white kidney bean. It works by reducing your body's absorption of starchy carbohydrates. Since you absorb fewer calories, you lose weight. Research has also shown that you burn more fat while taking Phaseolamin. 5HTP—works by increasing the level of Serotonin in the brain resulting in more stable emotions, better sleep, acts as appetite suppressant, weight loss and mild mood booster.

Glucomannan expands several times its own weight, thereby helping to curb the appetite, it also picks up and removes fat from the colon walls.

Chitosan flushes fat out of the body through colon system by bonding and making indigestible clusters of fat.

Lecithin breaks down fat so it can be removed from the body.

Choline and Inositol help the body burn fat.

Dehydroepiandrosterone (DHEA) inhibits an enzyme that is involved in fat production.

Amino acids that decrease body fat include: Taurine, L-Arginine and L-ornithine plus L-lysine, L-Carnitine, and L-Methionine.

Vitamins and Minerals helpful to weight control and energy include: C, B2, B6, B12, Zinc, Calcium, Chromium, and picolinate.

“Fat Attack” or “Fat-Sponge” novel super sweeteners and/or novel nutritional compositions for sugar and sweets craving control would include incorporation of one or combination of possibly all of the following ingredients: L-Glutamine, Vit. B3 (niacin), Phaseolamine, and Chromium picolinate

“Appetite—Arrest, Energy Everest” novel super sweeteners and/or novel nutritional compositions for suppressing appetite with incorporation of a)+b), or a combination of all of the following ingredients:

a) Gamma-aminobutyric acid (GABA),
b) L-Tyrosine,
c) L-Phenylalanine, tells the brain you are not hungry,
d) 5HTP-works by increasing the level of Serotonin in the brain resulting in more stable emotions, better sleep, acts as appetite suppressant, weight loss and mild mood booster,
e) Phaseolomine,
f) Glucomannan—it expands several times of its own weight, thereby helping to curb the appetite, it also picks up and removes fat from the colon walls.

Novel antidepressant sweeteners and/or novel nutritional compositions for energy boost and elevation of depression would include incorporation of a)+b)+c)+d)+e)+f) or their combinations as follows:

a) Gotu Kola, Saint John's Wort, Wheatgrass, Spirulina, Fennel, Kelp, Alfalfa, Red Clover, and/or
b) Adenosine A(2A) receptor blockers: caffeine, theobromine, theophylline, SCH 58261, KW 6002, and ZM 241385,
(They are widely used as stimulants of the central nervous system to induce vigilance and increase the time spent awake and can act as antidepressant agents. There is numerous scientific data proving that adenosine accumulates in the extra cellular space of the basal forebrain during wakefulness, increasing the sleep propensity. The blockade of the adenosine A(2A) receptor using adenosine receptor antagonists (blockers) have been found to reverse adenosine-mediated ‘depressant’ effect and thus are used in novel super sweeteners as effective antidepressant agents) and/or
c) Ephedra, guarana, kola nut and/or
d) Free-form amino acid complex+L-glutamine+L-tyrosine+S-adenosylmethionine (SAM)-derivative of amino acid L-methionine. They treat symptoms of Chronic Fatigue, which occur as a result of depression,
e) Pantothenic Acid—it helps to convert fats, carbohydrates and proteins into energy;
f) Taurine—It is a building block of all the other amino acids, as well as a key component of bile, which is needed for the digestion of fats and the control of the serum cholesterol levels, atherosclerosis, edema, heart disorders, hypertension, has a protective effect on the brain.

Novel super sweeteners and/or novel nutritional compositions for reduction of high blood pressure and prevention of heart disease include incorporation of:

a) L-Carnitine+L-glutamic acid+L-glutamine+Taurine,
b) DHEA, according to claim 24.22,
c) Odorless Garlic,
d) Coenzyme Q10
e) Essential fatty acids: black currant seed oil, flax seed oil, olive oil, primrose oil,
f) Vitamin C, Calcium, Magnesium, Selenium
g) Pectin

Novel super sweeteners and/or nutritional compositions for:
helping patients with rheumatoid arthritis,
sport or automobile related injuries that cause pain, swelling, sprains and strains;
headache,
   would include incorporation of Bromelain, Salicin and Oil of Evening Primrose. Due to its anti-inflammatory action, Bromelain was reported to help patients with rheumatoid arthritis in preliminary research. In that trial, in which Bromelain was given for varying (3-week to 13-month) periods, 73% had good to excellent results. Bromelain is an anti-inflammatory agent and for this reason is helpful in healing injuries, particularly sprains and strains, muscle injuries, and the pain, swelling, and tenderness that accompany sports injuries. Bromelain is most effective for injuries in which there is a congestion of blood or heavy bruising. Because it is a protein digestive agent, bromelain digests trapped blood byproducts. It is more effective for sprains and strains than it is for joint pain.

Novel super sweeteners and/or novel nutritional compositions would include incorporation of Salicin for: mild colds, influenza, headaches, pain, smooth skin. Salicin is helpful for mild feverish colds and infections (influenza), acute and chronic rheumatic disorders, mild headaches, and pain caused by inflammation. Does not have the dangerous side effects associated with Aspirin. Salicylic acid is the active ingredient in many skin-care products for the treatment of acne. It helps acne by causing skin cells to slough off more readily, preventing pores from clogging up.

Novel super sweeteners and/or novel nutritional compositions for B protection from the effects of the exposure to environmental toxicity, pollution, and cancer prevention would include incorporation of:

a) Antioxidants,
b) DHEA,
c) Enzymes,
d) Apple pectin,
e) Iscador—extract of mistletoe Viscum album
f) Amino acids: L-Cystine+L-methionine+L-carnitine,
g) Vitamins: C, A, E.

Novel super sweeteners and/or nutritional compositions for elimination and control of drug addiction would include incorporation of:

a) Vitamin B complex+B12+C,
b) Calcium and magnesium,
c) Protein powder (according to claim 27)+Lecithin,
d) Free-form amino acid complex+L-glutamine+L-tyrosine+S-adenosylmethionine (SAM)-derivative of amino acid L-methionine. They treat symptoms of Chronic Fatigue, due to withdrawal),
e) Gamma-aminobutyric acid(GABA)—acts as relaxant and lessens cravings,
f) Glutathione—reduces the desire for drugs, aids in detoxifying drugs to reduce their harmful effects,
g) Decoction of common oats (Avena sativa),
h) Lithium—aids in relieving depression,
i) L-phenylalanine, Niacinamide—necessary as a brain fuel and for withdrawal symptoms;
j) Gotu Kola, Wheatgrass, Spirulina, Fennel, Kelp, Alfalfa,
k) Ephedra, guarana, kola nut Novel super sweeteners and/or nutritional compositions for elimination and control of alcohol addiction with incorporation of:
a) Glutathione+L-methionine—protects the liver, detoxifies and reduces craving for alcohol,
b) Free form amino acid complex+L-cysteine and/or N-acetilcysteine—aids in withdrawal from alcohol and needed for brain and liver function and necessary for regeneration of liver cells,
c) L-glutamine—(decreases the desire for alcohol and enhance mental functioning)+L-tyrosine+S-adenosylmethionine (SAM)—derivative of amino acid L-methionine. They treat symptoms of Chronic Fatigue, due to withdrawal),
d) Pantothenic acid (vitamin B5), Vitamin B1 (thiamine)-aids the body in alcohol detoxification,
e) Vitamin B complex+Vitamin B12,
f) Vitamin C with bioflavonoids+Calcium and magnesium
g) Gotu Kola, Wheatgrass, Spirulina, Fennel, Kelp, Alfalfa,
h) Ephedra, guarana, kola nut

Novel super sweeteners and/or novel nutritional compositions for elimination and control of smoking addiction with incorporation of the following:

Decoctions of herbal constituents:
a) Gotu Kola, Wheatgrass, Spirulina, Fennel, Kelp, Alfalfa, Dong Quai, Red Clover, Ginger Root and/or
b) common oats (Avena sativa), Schizandra, Alfalfa, Echinacea, Licorice Root, Catnip, Passion Flower, Lobelia, Hops, Skullcap, Peppermint, Gentian, Myrrh, Safflower, Bayberry root bark, Eucalyptus, Sarsaparilla, Slippery Elm, and/or Valerian root, and/or
c) Ephedra, guarana, kola nut and/or
Free-form amino acid complex+L-glutamine+L-tyrosine+S-adenosylmethionine (SAM)—derivative of amino acid L-methionine. They treat symptoms of Chronic Fatigue, due to withdrawal);

### Copper, folic acid, L-Cystine, potassium, selenium, zinc, Vitamins: A, C, B12, E.

Novel super sweeteners and/or novel nutritional compositions for athletic performance and bodybuilding would include incorporation of the constituents:

a) Inosin,
(which acts as a metabolic activator and increases oxygen-carrying capacity and promote levels of ATP (Adenosine Tri-Phosphate)—a high energy compound that helps muscle contraction. Inosin increases the body's natural ability to handle strenuous exercise, workouts, intense training programs, and competitive events. Inosin belongs to a chemical family called purine nucleotides, the structural units of human body's RNA (ribonucleic acid) and DNA (deoxyribonucleic acid. Inosin boosts the production of ATP thus improving respiration and oxygen transport. Inosin also promotes the production of a substance known as 2,3 DPG which is necessary for the transport of oxygen molecules from the red blood cells to other cells for energy. For this reason, Inosin is used by athletes, who wish to exercise longer without experiencing muscle fatigue), and
b) Myoglobin, which boosts a healthy energy and additional extra muscle performance. (In contact with venous blood, oxygen combines more readily with Myoglobin than it does with hemoglobin, favoring the transfer of oxygen from blood to muscle cells. Thus, the oxygen that the working muscle requires for the energy-producing biochemical reactions is provided through digestion of novel super sweet sugar, containing Myoglobin) and
c) Pantothenic acid (vitamin B5), (which helps to convert fats, carbohydrates and proteins into energy. It also enhances stamina and prevents certain forms of anemia).

Novel super sweeteners and/or novel nutritional compositions according for slowing aging+increase of the muscle mass with the body fat reduction, osteoporosis prevention+increase of sex drive for both men and women would include incorporation of a combination of first two, or three or all of the following:

a) Ornithine+Arginine+Carnitine+DHEA (Omithine is important since it induce the release of Human Growth Hormone (HGH) in the body, which in turn helps with fat metabolism. It is further required for a properly functioning immune system and liver and assists in ammonia detoxification and liver rejuvenation. It is also of use in healing and repairing skin and tissue and is found in both these body parts. DHEA is a hormone known also to have anti-aging properties; it helps to generate the sex hormones estrogen and testosterone, increases muscle mass, stimulates bone deposition, thereby helping to prevent osteoporosis.)
b) Ginkgo biloba, Evening primrose oil, Yerba mate,
c) Flavonoids,
d) Green tea,
e) Folic acid,
f) vitamin B12, vitamin E, vitamin C.

It was determined by the inventor that the sweetness of final super sweet crystallized sugar will increase two times as much as regular sugar, when 1220-1250 mL of saturated sugar liquor (with approximately 80% of sugar content), extracted during sugar cane or sugar beets refining process after final filtration of saturated sugar liquor, sweetened with 3.2 g of stevioside extract with SEV (sucrose equivalent value)=250. Solution of 2.3 g (half of a tea spoon) of novel super sweet sugar in 230 ml of water (1%) was equally sweet compared to the standard 2% solution of sucrose (Redpath granulated sugar in tap water, pH about 8.0), containing 4.6 g (1 tsp) of regular crystal sugar in 230 ml of water.

New crystallized sugar consequently contained 0.32% of Stevioside extract and 99.68% of sucrose and was 2 times sweeter than regular sugar.

It was determined that the sweetness of final crystallized sugar will increase 3 times as much as regular, when 1220-1250 mL of saturated sugar liquor (with approximately 80% of sugar content), extracted during sugar cane or sugar beets refining process after final filtration sweetened with 4.8 g of stevioside extract with SEV (sucrose equivalent value)=250.

New crystallized sugar consequently contained 0.48% of Stevioside extract and 99.52% of sucrose and was 3 times sweeter than regular sugar.

6.4 g of stevioside extract in 1220-1250 mL of saturated sugar liquor (with approximately 80% of sugar content), during sugar cane or sugar beets refining process increased the sweetness of final super sweet granulated sugar 4 times.

New crystallized sugar consequently contained 0.64% of Stevioside extract and 99.36% of sucrose and was 4 times sweeter than regular sugar.

Similar results of increased sugar sweetness were found using other sweeteners with different sweetening power, stable to high heat and increased pressure. The increases in sweetness of new crystallized sugar at the end of the sugar refining process were determined further depending on the amounts of other sweeteners added to filtered sugar juice and sweetening power of each sweetener. See the results in Table 1. From the results, comprised in Table 1 it is clearly seen that new sugars can be made with SEV reaching up to 3000% and more, having at the same time the sucrose content equal to 99% and over.

TABLE 1
Proportions between the amounts of different sweetener
added to filtered sugar juice and the increase in sweetness of
novel crystallized sugars at the end of the sugar refining
process.

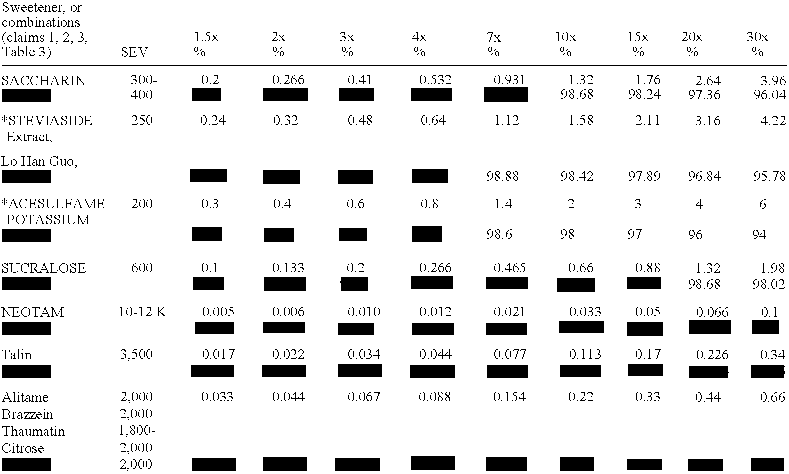

The top number in each cell represents the amount of high intensity sweetener (%),
The bottom number represents the amount of sucrose (%).
The yellow color in Table 1, 2 highlights new sugars with the amount of sucrose over 99%.
SEV—sucrose equivalent value.

TABLE 2
Sucrose + . . . = 75-99%, according to claim 3. Proportions between the
amounts of different sweetener added to filtered sugar juice, amounts of sucrose and the
increase in sweetness of novel crystallized sugars at the end of the sugar refining process.
Combinations and blending of each sweetener provides also synergy of sweetness to
new sugars. A mixture of two sweeteners has a higher level of sweetness than would
be predicted based on the sweetness of the separate components. Synergy can permit
lower usage levels and lower cost. Money can also be saved by blending a more
expensive sweetener with a less expensive one. See Table 3.
Blending sweeteners can mask taste defects of individual sweeteners. In many
cases, the temporal (time-intensity) profile can be improved, as well.

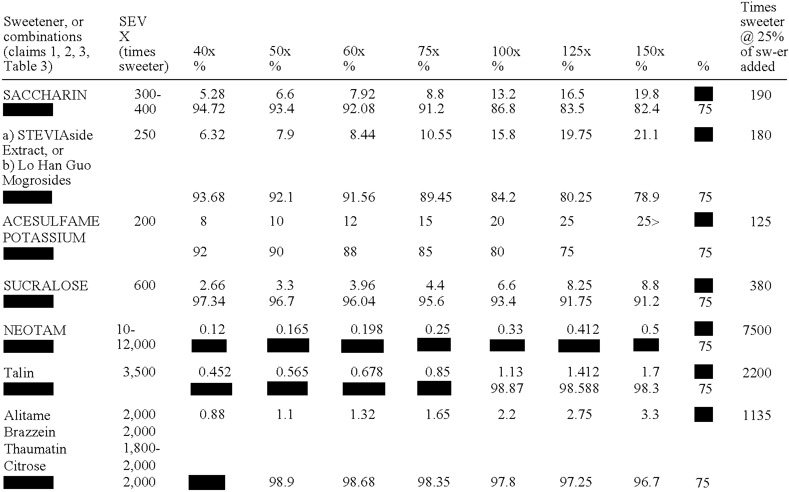

TABLE 3
Sweeteners' Formulas (Combinations). 100% here is total content of high
sweeteners incorporated in saturated sugar liquor during sugar refining process,
according to claims 1, 2, 3 and proportions in Tables 1, 2!

| | 100% | | | |
|---|---|---|---|---|
| | 45–96% | | | |
| Claim # | 15–32% | 15–32% | 15–32% | 55–4% |

| | | |
|---|---|---|
| 12 | Cyclamate + Acesulfame K + Saccharin | +Sucralose (or with one or two |
| | | sw-ner separ.) |
| 13 | Cyclamate + Acesulfame K + Saccharin | +Citrose (or with one or two |
| | | sw-ner separ.) |
| 14 | Cyclamate + Acesulfame K + Saccharin | +Neotame (or with one or two |
| | | sw-ner separ.) |
| 15 | Cyclamate + Acesulfame K + Saccharin | +Thaumatin (or with one or two |
| | | sw-ner separ.) |
| 16 | Cyclamate + Acesulfame K + Saccharin | +Talin (or with one or two |
| | | sw-ner separ.) |
| 17 | Cyclamate + Acesulfame K + Saccharin | +Alitame (or with one or two |
| | | sw-ner separately) |
| 18 | Cyclamate + Acesulfame K + Saccharin | +Steviaside (or with one or two |
| | | sw-ner separately) |
| 19 | Cyclamate + Acesulfame K + Saccharin | +Lo Han Guo (or with one or |
| | | two sw-ner separately) |
| 20 | Cyclamate + Acesulfame K + Saccharin | +Glycyrrhizin (or with one or two sw-ner |
| | | separately) |

| | |
|---|---|
| 21 | Lo Han Guo + Tagatose + Glycyrrhizin + Steviaside |
| 22 | Xylitol + Lo Han Guo + Tagatose + Glycyrrhizin + Steviaside |
| 23 | Erythritol + Lo Han Guo + Tagatose + Glycyrrhizin + Steviaside (no side |
| | effects of diarrhea, like with other Sugar alcohols) |

There are also combinations (that we claim) of sucrose with one of each or more sweeteners or food additives (flavor enhancers): fructose, glucose, natural and/or artificial honey, maple syrup, tagatose, inulin-FOS and sugar alcohols.

It must be understood that the invention is in no way limited to the above embodiments, combinations and amounts of each ingredient according to all claims, Tables 1, 2, 3 and that many changes my be brought thereto without departing from the scope of the invention as defined by the appended claims.

What is claimed is:

1. A method for increasing the sweetness of regular sugar made during the refining process of sugar beets and sugar cane, the method comprising:
a) a first step of forming a mixture of raw juice extracted from sugar cane or sugar beets with a milk of lime and a carbon dioxide gas in carbonation tanks so that the carbon dioxide bubbles through the mixture forming calcium carbonate and non-sugar particles in the mixture attach themselves to the calcium carbonate and settle to the bottom of the tanks;
b) a second step of filtering the mixture, leaving a golden light brown clarified thin juice,
c) a third step of boiling the juice under vacuum until a sufficient quantity of water is evaporated from the juice to form a syrup having a consistency of pancake syrup;
d) a fourth step of filtering the syrup in an after filter to remove all non-sugar materials to form a saturated sugar liquor;
e) a fifth step of mixing the saturated sugar liquor with at least one high intensity sweetener in a large mixer;
f) a sixth step of transferring the mixture the saturated sugar juice and the at least one high intensity sweetener to boiling pans and boiling the mixture of saturated sugar juice and at least one high intensity sweetener under vacuum until crystals begin to form a super sweet massecuite comprising a mixture of super sweet sugar crystals and super sweet syrup;
g) a seventh step of transferring the super sweet massecuite to centrifuges for separation by spinning rapidly in a perforated cylindrical basket to form a super sweet molasses syrup thrown off through perforations in the perforated cylindrical basket with the super sweet sugar crystals remaining in the perforated cylindrical basket;
h) an eighth step of processing further the super sweet molasses syrup (if it is not used further commercially) that remains after the sugar crystals are initially separated by removing more super sweet sugar crystals from the remaining molasses to produce a super sweet sugar syrup.

2. The method of claim 1 wherein an amount of sucrose in the super sweet sugar syrup is more than 99% and/or the super sweet sugar syrup, or the super sweet molasses has a Sucrose Equivalent Value (SEV) from at least 150% to 3000%.

3. The method of claim 1 further comprising a ninth step of washing the super sweet sugar crystals in clean hot water to produce pure white damp super sweet sugar crystals;
a tenth step of drying the damp super sweet sugar crystals with filtered air in a rotating drum granulator and passing the dried new super sweet sugar crystals over screens which separate the various sizes of the new super sweet sugar crystals; and
an eleventh step of drying each of the various sizes of the new super sweet sugar crystals through a curing process and then packaging the various sizes of the new super sweet sugar crystals into various retail and commercial packages for shipping to stores and food manufacturers.

4. The method of claim 3 wherein the super sweet sugar crystals are formed to be at least 1.5-30 times sweeter than regular sucrose.

5. The method of claim 3 wherein an amount of sucrose in the super sweet sugar crystals is more than 99% and the super sweet sugar crystals have a Sucrose Equivalent Value (SEV) from at least 150% to 3000%.

6. The method of claim 1 wherein the fifth step comprises mixing the saturated sugar liquor with at least one high intensity sweetener in a large mixer, the high intensity sweetener taken from a list of high intensity sweeteners including: a sweet protein taken from the list of sweet proteins including Stevioside and rebaudiside-A extract, Lo Han Guo Mogrosides extract, Brazzein, Curculin, Glycyrrhizin, Thaumatin, Monellin, Pentadin, Mabinlin as natural sweeteners; Acesulfame Potassium, Sucralose, Neotam, Talin, Thaumatin, Citrose, Alitame, Cyclamate, Saccharin; a sugar alcohols taken from the list of sugar alcohols including erythritol, xylitol, sorbitol, lactitol, mannitol, and maltitol; Tagatose, Inulin-FOS (FructoOligoSaccharide); and other sweeteners.

7. The method of claim 6 wherein the fifth step further comprises mixing the saturated sugar liquor with at least one natural sweetener taken from the list of natural sweeteners including: fructose, isoglucose, natural honey, artificial honey, maple syrup, amasake, barley malt, brown rice syrup, concentrated fruit sweetener, date sugar, tagatose, sugar alcohols, and Inulin-FOS; and
mixing the saturated sugar liquor and natural sweetener mixture with the mixture of the saturated sugar juice and the at least one high intensity sweetener.

8. The method of claim 7 wherein an amount of sucrose alone in the super sweet sugar syrup and the super sweet sugar crystals or a combination of sucrose and at least one of the group of natural sweeteners including fructose, glucose, honey, maple syrup, tagatose, sugar alcohols, inulin-FOS in the super sweet sugar syrup and the super sweet sugar crystals comprises between 75-99% and the Sucrose Equivalent Value (SEV) is greater than 3000%.

9. The method of claim 7 wherein the super sweet sugar crystals and the super sweet sugar syrup each contain at least 99% sucrose to reduce calorie intake and glycemic effect due to increased sweetness without increase of calories and to enable proportionate reduction of the amount of regular sugar and carbohydrates needed for sweetening foods and beverages so that the weight, volume, amount of carbohydrate and energy (calorie value) of which will be proportionately reduced by number of times the super sweet sugar crystals and the super sweet sugar syrup are each sweeter then regular sugar to help to prevent health problems associated with excess sugar consumption including obesity, atherosclerosis, diabetes, and tooth decay.

10. The method of claim 7 wherein the fifth step further comprises mixing the saturated sugar liquor with at least one of the following list of sweeteners including the sweeteners artificial maple syrup, a soluble fiber Inulin-FOS (FructoOligoSaccharide), stevia extract, a Lo Han Guo extract, and Neotame to make the saturated sugar liquor sweeter and to enhance health and other benefiting qualities of granulated sugars including assisting in breast cancer prevention and treatment for women, assisting in the prevention and elimination of viruses spread including hepatitis C, immune deficit virus, pneumonia virus, SARS virus (sugars containing flavoring agent Glycyrrhizin), enhancing a prebiotic effect and digestion by enhancing and promoting beneficial intestinal bacterial growth in the large intestine after consumption of food, assisting in the prevention of ear, nose and throat infections, osteoporosis, insulin resistance, diabetes, hypertension, and hormonal imbalances.

11. The method of claim 1 wherein the fifth step comprises mixing the saturated sugar liquor with from fifteen to thirty-two percent each of Cyclimate, Acesulfame K and Saccharine and from fifty-five to four percent proportionally of at least one of the following additives including the additives Sucralose, Citrose, Neatame, Thaumatin, Talin, Alitame, Steviaside, Lo Han Guo, and Glycyrrhizin.

12. The method of claim 1 wherein the fifth step comprises mixing the saturated sugar liquor with Lo Han Guo, Tagatose, Glycyrrhizin, and Steviaside.

13. The method of claim 1 wherein the fifth step comprises mixing the saturated sugar liquor with Xylitol, Lo Han Guo, Tagatose, Glycyrrhizin, and Steviaside.

14. The method of claim 1 wherein the fifth step comprises mixing the saturated sugar liquor with Erythritol, Lo Han Guo, Tagatose, Glycyrrhizin, and Steviaside.

15. The method of claim 7 wherein the fifth step further comprises mixing the super saturated sugar liquor or novel super sweet crystallized sugars with therapeutically effective and regulatory safe dosages of at least one of the following list of ingredients including the ingredients Bromelain; Chitosan; Salicin; Inosin; Myoglobin; Glucomannan; Guaranine; Yerba mate, Pectin; Pancreatin; Pantothenic Acid; Spirulina; Adenosine Tri-Phosphate; Conjugated Linoleic Acid (CLA); Hydroxycitic Acid (HCA); Phaseolamin; 5HTP; Adenosine receptor antagonists including caffeine, theobromine, theophylline, SCH 58261, KW 6002, cocoa powder, coffee, and ZM 241385; Lecithin; Choline and inositol; Gamma-aminobutyric acid (GABA); Dehydroepiandrosterone (DHEA); Amino acids including L-Arginine, L-Omithine, L-lysine, L-Carnitine, L-Glutamine, L-Methionine, L-Phenylalanine; L-Tyrosine, L-Cysteine, and L-methionine; Enzymes including Superoxide Dismutase (SOD), papain, bromelain, proteolytic and pancreatic enzymes; antioxidants including Alpha-Lipoic Acid, Bilberry, Coenzyme Q10, Cysteine, Ginkgo Biloba, Glutathione, Grape Seed Extract, Green Tea, Melatonin, Oligomeric Proanthocyanidins (OPCs) from pine bark (Pycnogenol), Taurine and grape seed extracts; vitamins including C, A, Beta-Carotene, D, E, B1, B2, B3, B5, B6, B12, B-complex, Biotin, Choline, and Folic Acid; minerals including Selenium, Zinc, Boron, Calcium, Chromium, Copper, Iron, Magnesium, and Potassium; and Aspartame.

16. The method of claim 7 further comprising adding the super sweet sugar crystals and/or super sweet sugar syrup, or super sweet molasses to at least one consumable item taken from the list of consumable items including meal replacements; baked and fried goods including doughnuts, muffins, cakes, pizzas, potato chips, corn chips, and french-fries; cereals; bakery fillings; dairy products including ice cream products, cheeses, yogurts, and frozen yogurts; soy beverages; soy products; chocolate; chocolate bars; sport performance nutritional products; candies; puddings; chewing gums; sweet coatings for nuts; and other snack products.

17. The method of claim 7 further comprising mixing the super sweet sugar crystals and/or super sweet sugar syrup, or super sweet molasses with at least one orally ingestible health benefiting nutritional compositions for humans and animals taken from the list of ingestible health benefiting nutritional compositions for humans and animals including super sweeteners; nutritional supplements including proteins including casein, soya protein isolates, spirulina, and egg albumin used in protein powder, protein and water base solutions, protein in water based beverages, amino acid powder, amino acid water based solutions, and amino acid water based beverages, and fats including butter, olive oil, canola oil, vegetable oil, flax seed oil, black currant seed oil, primrose oil, fish oil, and Omega 3, 6, 9 polyunsaturated fatty acids, dry coffee extracts, coffee extract beverages, cacao, black teas, green teas, milk, condensed milk, honey, maple syrup, dry fruit, vanillin, dry vegetables, ice cream, yogurt, wheat flower, multigrain flower, cheeses, nuts, mixtures of protein and fat, mixtures of protein and polyunsaturated fatty acids, mixtures of amino acids and fat, and mixtures of amino acids and polyunsaturated fatty acids; fruit juices; vegetable juices; fruit beverages; vegetable beverages; concentrated fruit juices; concentrated vegetable juices, concentrated fruit beverages, concentrated vegetable beverages; solutions of gelatin in water; solutions of pectin in water; and solutions of agar in water.

18. The method of claim 7 further comprising adding the super sweet sugar crystals and/or super sweet sugar syrup or super sweet molasses to at least one composition for obesity, weight loss and cholesterol reduction from the list of compositions for obesity, weight loss and cholesterol reduction including conjugated Linoleic Acid (CLA); Hydroxycitic Acid (HCA) derived from a fruit, Garcinia cambogia or Malabar tamarind; Phaseolomine derived from white kidney beans; 5HTP; Lecithin; Choline; Inositol; Dehydroepiandrosterone (DHEA); Amino acids including Taurine, L-Arginine and L-ornithine plus L-lysine, L-Carnitine, L-Methionine; and vitamins and minerals including C, B2, B6, B12, Zinc, Calcium, and Chromium picolinate.

19. The method of claim 7 further comprising mixing the super sweet sugar crystals and/or super sweet sugar syrup or super sweet molasses with at least one composition for sugar and sweets craving control taken from the list of compositions for sugar and sweets craving control including L-Glutamine, Vit. B3 (niacin), Phaseolamine, and Chromium picolinate,

20. The method of claim 7 further comprising mixing the super sweet sugar crystals and/or super sweet sugar syrup or super sweet molasses with at least one composition for “appetite arrest and energy everest” taken from the list of compositions for “appetite arrest and energy everest” including Gamma-aminobutyric acid (GABA), L-Tyrosine, L-Phenylalanine, 5HTP, Phaseolomine, Glucomannan.

21. The method of claim 7 further comprising mixing the super sweet sugar crystals and/or super sweet sugar syrup or super sweet molasses with at least one composition to boost energy and elevate depression taken from the list of compositions to boost energy and elevate depression including Gotu Kola; Saint John's Wort; Wheatgrass; Spirulina; Fennel; Kelp; Alfalfa; Red Clover; Adenosine A(2A) receptor blockers including caffeine, theobromine, theophylline, SCH 58261, KW 6002, and ZM 241385; Ephedra; guarana; kola nut; free-form amino acid complex; L-glutamine; L-tyrosine; S-adenosylmethionine (SAM); derivative of amino acid L-methionine; Pantothenic Acid; and Taurine.

22. The method of claim 7 further comprising mixing the super sweet sugar crystals and/or super sweet sugar syrup or super sweet molasses with at least one composition for reduction of high blood pressure and prevention of heart disease taken from the list of compositions for reduction of high blood pressure and prevention of heart disease including L-Carnitine; L-glutamic acid; L-glutamine; Taurine; DHEA; Odorless Garlic; Coenzyme Q10; essential fatty acids including black currant seed oil, flax seed oil, olive oil, and primrose oil; Vitamin C; Calcium; Magnesium; Selenium; and Pectin.

23. The method of claim 7 further comprising mixing the super sweet sugar crystals and super/or sweet sugar syrup or super sweet molasses with at least one composition for weight loss, cholesterol reduction, energy boost, antidepression and high blood pressure reduction, and diabetes taken from the list of compositions for weight loss, cholesterol reduction, energy boost, antidepression and high blood pressure reduction, and diabetes including conjugated Linoleic Acid (CLA); Hydroxycitic Acid (HCA) derived from a fruit, Garcinia cambogia or Malabar tamarind; Phaseolomine derived from white kidney beans; 5HTP; Lecithin; Choline; Inositol; Dehydroepiandrosterone (DHEA); Amino acids including Taurine, L-Arginine and L-ornithine plus L-lysine, L-Carnitine, L-Methionine; vitamins and minerals including C, B2, B6, B12, Zinc, Calcium, and Chromium picolinate; L-Glutamine; Vit. B3 (niacin); Phaseolamine; Chromium picolinate; Gamma-aminobutyric acid (GABA); L-Tyrosine; L-Phenylalanine; 5HTP; Phaseolomine, Glucomannan; Gotu Kola; Saint John's Wort; Wheatgrass; Spirulina; Fennel; Kelp; Alfalfa; Red Clover; Adenosine A(2A) receptor blockers including caffeine, theobromine, theophylline, SCH 58261, KW 6002, and ZM 241385; Ephedra; guarana; kola nut; free-form amino acid complex; L-glutamine; L-tyrosine; S-adenosylmethionine (SAM); derivative of amino acid L-methionine; Pantothenic Acid; Taurine; Odorless Garlic; Coenzyme Q10; essential fatty acids including black currant seed oil, flax seed oil, olive oil, and primrose oil; Vitamin C; Calcium; Magnesium; Selenium; and Pectin.

24. The method of claim 7 further comprising mixing the super sweet sugar crystals and/or super sweet sugar syrup or super sweet molasses with at least one composition for rheumatoid arthritis, sport and automobile related injuries, and headaches taken from the list of compositions for rheumatoid arthritis, sport and automobile related injuries, and headaches including Bromelain, Salicin and oil of evening primrose.

25. The method of claim 7 further comprising mixing the super sweet sugar crystals and/or super sweet sugar syrup or super sweet molasses with Salicin for mild colds, influenza, headaches, pain, and smooth skin.

26. The method of claim 7 further comprising mixing the super sweet sugar crystals and/or super sweet sugar syrup or super sweet molasses with at least one composition for 13 protection from the effects of the exposure to environmental toxicity, pollution, and cancer prevention taken from the list of compositions for 3 protection from the effects of the exposure to environmental toxicity, pollution, and cancer prevention including antioxidants; DHEA; Enzymes; Apple pectin; Iscador; Amino acids including L-Cystine, L-methionine, L-carnitine; and Vitamins including C, A, and E.

27. The method of claim 7 further comprising mixing the super sweet sugar crystals and/or super sweet sugar syrup or super sweet molasses with at least one composition for elimination and control of drug addiction taken from the list of compositions for elimination and control of drug addiction including Vitamin B complex; Vitamin B12; Vitamin C; Calcium; magnesium; protein powder; Lecithin; free-form amino acid complex; L-glutamine; L-tyrosine; S-adenosylmethionine (SAM); Gamma-aminobutyric acid (GABA); Glutathione; decoction of common oats (Avena sativa); Lithium; L-phenylalanine; Niacinamide; Gotu Kola; Wheatgrass; Spirulina; Fennel; Kelp; Alfalfa; ephedra; guarana; and kola nut.

28. The method of claim 7 further comprising mixing the super sweet sugar crystals and/or super sweet sugar syrup or super sweet molasses with at least one composition for elimination and control of alcohol addiction taken from the list of compositions for elimination and control of alcohol addiction including Glutathione; L-methionine; free form amino acid complex; L-cysteine; N-acetilcysteine; L-glutamine; L-tyrosine; S-adenosylmethionine (SAM); Pantothenic acid (vitamin B5); Vitamin B1 (thiamine); Vitamin B complex; Vitamin B12; Vitamin C with bioflavonoids; Calcium; magnesium; Gotu Kola; Wheatgrass; Spirulina; Fennel; Kelp; Alfalfa; Ephedra; guarana; and kola nute

29. The method of claim 7 further comprising mixing the super sweet sugar crystals and/or super sweet sugar syrup or super sweet molasses with at least one composition for elimination and control of smoking addiction taken from the list of compositions for elimination and control of smoking addiction including decoctions of herbal constituents Gotu Kola, Wheatgrass, Spirulina, Fennel, Kelp, Alfalfa, Dong Quai, Red Clover, and Ginger Root; common oats (Avena sativa; Schizandra; Alfalfa; Echinacea; Licorice Root; Catnip; Passion Flower; Lobelia; Hops; Skullcap; Peppermint; Gentian; Myrrh; Safflower, Bayberry root bark; Eucalyptus; Sarsaparilla; Slippery Elm; and Valerian root; Ephedra; guarana; kola nut; free-form amino acid complex; L-glutamine; L-tyrosine; S-adenosylmethionine (SAM); Copper; folic acid; L-Cystine; potassium; selenium; zinc; and Vitamins including A, C, B12, and E.

30. The method of claim 7 further comprising mixing the super sweet sugar crystals and/or super sweet sugar syrup or super sweet molasses with at least one composition to enhance athletic performance and bodybuilding taken from the list of compositions to enhance athletic performance and bodybuilding including Inosin; Myoglobin; and Pantothenic acid (vitamin B5).

31. The method of claim 7 further comprising mixing the super sweet sugar crystals and/or super sweet sugar syrup or super sweet molasses with at least one composition to slowing aging and increase of the muscle mass with the body fat reduction, help prevent osteoporosis, and increase of sex drive for both men and women taken from the list of compositions to slowing aging and increase of the muscle mass with the body fat reduction, help prevent osteoporosis, and increase of sex drive for both men and women taken including Ornithine; Arginine; Carnitine; DHEA; ginkgo biloba; evening primrose oil; yerba mate; flavonoids; green tea; folic acid; vitamin B12; vitamin E; and vitamin C.
